(19) United States
(12) Patent Application Publication
(10) Pub. No.: US 2011/0222301 A1
(43) Pub. Date: Sep. 15, 2011

(54) Dynamic lighting system

(75) Inventors: Horst Knoedgen, München (DE); Siegfried Luger, Dornbirn (AT)

(73) Assignee: Digital Imaging Systems GmbH and Luger Research e. U.

(21) Appl. No.: 12/660,989

(22) Filed: Mar. 9, 2010

(51) Int. Cl. B60Q 1/076; F21S 8/00; F21V 9/16

(52) U.S. Cl. 362/467; 362/277; 362/84

(57) ABSTRACT

Methods and systems for dynamic lighting systems are disclosed. The dynamic lighting system invented has minimal mechanical wear and is reacting quickly to fast changes by using magnetic power transmission moving optical elements between light sources, preferably types of LEDs or OLEDS, and objects to be illuminated. Movements of the optical elements can be either linear in up to three dimensions, tilted or on spherical tracks. Positions of the optical elements can be progressively taken and appointed.

This application is related to the following US patent applications:

DI08-004, titled “Camera Shutter”, Ser. No. 12/658,508, filing date Feb. 5, 2010, and
DI09-007, titled “Twin-actuator configuration for a camera module”, Ser. No. ______, filing date ______,
and the above applications are herein incorporated by reference in their entirety.

### BACKGROUND OF THE INVENTION

(1) Field of the Invention

This invention relates generally to lighting systems and relates more specifically to dynamic lighting systems in which the animated element is steered by a magnetic field.

(2) Description of the Prior Art

Lighting applications require an increasing amount of dynamic lighting systems. The reason for this development is partly due to the increasing flexibility of working areas and living quarters and partly because of a rising demand for situational lighting scenes. From a technological point of view, the development of LED (white and colored) has supported and fostered the demand for alterable light.

The light direction, light distribution, color distribution and the stability of the light all play a big role in the application. Rigid systems only cover particular illumination functions and must therefore be adjusted manually to comply with changing demands.

Familiar dynamic lighting systems are those whose optics can be set using a motor and transmission (e.g. US 2002/0036908A1—LED warning signal light and moveable row of LED's). This solution has the considerable drawback that the mechanical parts used in the system have more wear and tear, which has a negative effect on the operational life span. In addition, these systems are rather sluggish and cannot react quickly to fast changes.

Known systems based on motor-transmission elements can also get jammed when there are fluctuations in the temperature. Because modern lighting systems based on LED technology are exposed to temperature stress, an innovative solution is required offering significant advantages in relation to sturdiness when exposed to stress caused by temperature changes. As a result, mechanical tension in the lighting systems is avoided.

It is a challenge to accomplish a dynamic lighting system having an extended life span, allowing moving parts to be easily positioned and re-positioned while the different positions can be progressively taken and appointed.

Solutions dealing with lighting systems are described in the following patents:

U.S. Patent (U.S. Pat. No. 7,220,029 to Bynum et al.) teaches a lighting assembly being adjustable between flood and spot lighting conditions for selectively illuminating an interior passenger compartment in a motor vehicle. The assembly includes a housing, which clamps to a supporting member, such as a headliner, via a sleeve interacting with a rotary cam lock. An LED light source is orbitally supported within the housing for projecting light in a directionally adjustable manner. A lens is disposed in the light path and is moveable between an extended spot position for task lighting and a retracted flood position for general illumination within the interior compartment. A switch is responsive to movement of the lens into its spot position for automatically energizing the LED. The switch opens, thus de-energizing the LED when the lens is returned to its flood condition. A lighting control circuit is responsive to an override signal, such as from a door switch, for independently activating the light source when the lens is in its flood position. The light source is supported for orbital movement within the housing by a gimbal mechanism, which includes an inner gimbal carried in a cross. Pintles establish intersecting perpendicular axis to accomplish the orbital movement.

U.S. Patent Publication (US 2008/0198617 to Schwab et al.) discloses an LED adaptive forward lighting system for an automotive vehicle comprising a headlamp housing fixed to the vehicle for mounting LED lamp units having fixed light beam directions. The LED lamp units each have mounting pivots and link pivots that are spaced from one another to provide lever arms. The mounting pivots mount the LED lamp units on a bezel within the housing.

U.S. Patent Publication (US 2008/0266856 to Chien) describes a light device with changeable function which at least one of any conventional available light means install within housing-unit or joint-means and the said housing-unit and joint-means can be change the orientation, or position, or viewing angle, or others light properties related to any other of the said light means to allow the said light device emit light beam to desired direction to make illumination to viewer. The said light device selected incorporated with solar means, wind generator or other generators, home electricity to get the power to turn on the said preferred light means under predetermined functions.

U.S. Patent (U.S. Pat. No. 6,305,830 to Zwick et al.) teaches lighting optics for lights of vehicles, preferably motor vehicles. The lighting optics has a light-refracting lens element that is disposed in the path of rays of at least one light. The lens element has at least one aperture through which a portion of the rays of the light passes without undergoing refraction.

U.S. Patent (U.S. Pat. No. 5,151,580 to Metlitsky et al.) discloses a portable scanning head emitting and receiving light from a light-emitting diode to read symbols, such as bar-code symbols. The optics within the scanner is operative for focusing a light beam and the view of a light sensor in different planes exteriorly of a scanner housing. Imaging means are provided in the unit for imaging a viewing window. The viewing window has an area smaller than that of the scan spot. The system can employ an LED as a light source and tolerate the relatively large-sized (on the order of millimeters) scan spot without sacrificing reading performance since the photodiode “sees” only that portion of the scan spot visible through the viewing window.

### SUMMARY OF THE INVENTION

A principal object of the present invention is to achieve a dynamic lighting system having an extended life span.

Another principal object of the present invention is to achieve a dynamic lighting system having minimal mechanical wear.

Another principal object of the present invention is to achieve a dynamic lighting system having reduced mechanical dimensions.

Another principal object of the present invention is to achieve a dynamic lighting system having minimized movable mass.

Another principal object of the present invention is to achieve a dynamic lighting system having minimized energy demand for dynamization.

Another principal object of the present invention is to achieve a dynamic lighting system wherein the position of the moving element(s) can be continuously varied.

A further object of the present invention is to achieve a dynamic lighting system reacting quickly to fast changes.

A further object of the present invention is to achieve a dynamic lighting system being not sensitive to temperature fluctuations.

A further object of the present invention is to achieve a dynamic lighting system wherein movable elements are steered by a magnetic field.

A further object of the present invention is to achieve a dynamic lighting system wherein positions of movable elements can be progressively taken and appointed.

A further object of the present invention is to achieve a dynamic lighting system wherein moving parts can be positioned linearly, two-dimensionally or three-dimensionally.

In accordance with the objects of this invention a method for dynamic lighting systems avoiding mechanical tension enabled having utmost flexible positioning, has been achieved. The method invented comprises the following steps: (1) providing at least one light source, one or more movable optical elements (could be) to guide light from the at least one light source, a control module, and means of power transmission to move the optical elements to position desired up to three dimensions, wherein the optical elements could be e.g. lenses, mirrors, fiber optics, prisms, variable lenses, etc. (2) deploying a magnetic power transmission to move said optical elements, and (3) controlling said power transmission by said control module. Optionally the actual positions of the one or more movable optical elements are sensed and fed to the control module in a control loop.

In accordance with the objects of this invention a dynamic lighting system has been achieved. The lighting system invented firstly comprises: at least one light source, and at least one movable optical element guiding light from said at least one light source. Furthermore the lighting system comprises a power transmission changing a position of said at least one movable optical element by a controlled magnetic field, and means of bearing being connected to a static element of the lighting system guiding said at least one movable optical element.

### BRIEF DESCRIPTION OF THE DRAWINGS

In the accompanying drawings forming a material part of this description, there is shown:

FIG. 1a prior art shows an application of a lighting system, e.g. a prior art street light providing light on an ellipsoid area of a street.

FIG. 1b shows as example an embodiment of the present invention It shows a street light using the present invention having a dynamic light distribution curve, covering a much larger lighted area, but only where required, than the area covered by prior art. The improvement shown here is related to reduce “wasted light” outside the street. The light distribution follows the course of the street.

FIG. 2 shows axial definitions for a light deflector with three dimensionally deflection directions x, y, z.

FIG. 3 illustrates an embodiment of the dynamic lighting system with position steered optics using an intermediate optical element.

FIG. 4a illustrates the basic idea of the present invention. It shows an oblique view of the lighting system invented.

FIG. 4b shows a side view of the lighting system of the present invention, wherein the x-y table 41 is guided by balls 42 of ball bearings.

FIG. 5 shows another embodiment of the lighting system invented using steered optical elements to control the flux of light using a movable intermediate optical element.

FIG. 6 shows another embodiment of the lighting system invented with position dependent optics on spherical tracks 60.

FIG. 7 illustrates a multiple lighting system with a number of optical elements and numerous magnetic transmission stretches.

FIG. 8 depicts a lighting system invented having horizontal deflection.

FIG. 9 depicts a lighting system with multiple light sources having a common optical element, which can be moved over these multiple light sources.

FIGS. 10 a-c show principles of function of a first embodiment of a power transmission used with the present invention.

FIGS. 10 d-f shows the function principles of a second embodiment of a power transmission used with the present invention.

FIGS. 11a-c illustrate how the inductances of coils vary dependent on the positions of the moving part of the motor, i.e. the positions of the permanent magnets.

FIG. 12 a-c illustrate similarly how the inductance of coils vary dependent on the position of the moving part of the motor, i.e. the positions of the permanent magnet moving inside of the coils.

FIG. 13 depicts a block diagram of the basic functions of a control module for the lighting system invented.

FIG. 14 illustrates a flowchart for a method for dynamic lighting systems, avoiding mechanical tension, enabled having utmost flexible positioning.

FIGS. 15 a-c illustrate Alvarez lens technology comprising two optical elements (lenses) that can be used to generate different light distributions.

FIGS. 16 a-f show schematic functions of Alvarez- or Lohmann (alternative solution to the Alvarez lens) lens systems.

FIGS. 17 a-c show how the optical properties of a fluid-filled lens can be changed by changing the amount of fluid of the lens.

FIG. 18 shows an oblique view of main components of a preferred embodiment of the present invention.

FIG. 19 shows a top view of an enlarged clipping of the surface of an optical element of the lighting system invented in which micro-structured optics are integrated.

FIG. 20 illustrates a side view of two optical elements (plates) with micro-structured surfaces.

### DESCRIPTION OF THE PREFERRED EMBODIMENTS

Systems and methods for dynamic lighting systems having minimal mechanical wear and reacting quickly to fast changes by using magnetic power transmission moving optical elements between light sources have been invented.

The present invention discloses systems and methods in which one or more animated elements (e.g. the optics) are steered by a magnetic field, i.e. a linear motor. The moving part lies over e.g. a ball bearing. This type of system reduces the vulnerable mechanics (transmission) and is liable to much less mechanical sluggishness. The magnetic power transmission allows the moving parts to be positioned and in addition a position that was already appointed can be re-appointed.

FIG. 1a prior art shows an application of a lighting system, e.g. a prior art streetlight 1 providing light on an ellipsoid area 2 of a street 3.

FIG. 1b shows as example an embodiment of the present invention. It shows a streetlight 4 using the present invention having a dynamic light distribution curve. The improvement shown here is related to reduce “wasted light” outside the street. The light distribution follows the course of the street covering a much larger lighted area 5 and only where required than the area 2 covered by prior art shown in FIG. 1a prior art. The present invention achieves the enlargement of the lighted area, as desired only, by shifting the relative position of the light source of the street lamp and one or more optical elements. Such optical elements can be e.g. lenses, mirrors, fiber optics, prisms, variable lenses, etc. The shifting of the relative position between the light source and one or more optical elements is achieved by a power transmission based on controlled magnetic field. Such a power transmission can run with a high speed (e.g. above 100 Hz). The center of light is thus modulated, having small amplitude, above the visual frequency detection of the human eye. A linear motor with an integrated position sensing or another kind of position sensing as disclosed in the patent application DI08-004, titled “Camera Shutter”, Ser. No. 12/658,508, filing date Feb. 5, 2010, and in the patent application DI09-007, titled “Twin-actuator configuration for a camera module”, Ser. No. ______, filing date ______ could be e.g. used for this purpose. Capacitive position sensing or other types of position sensing could be used as well. The movable elements are guided by plain bearings, ball bearings, or other types of bearings. Balls of ball bearings could be used to conduct electrical currents in case ball bearings are used and the balls are made of electrically conductive material.

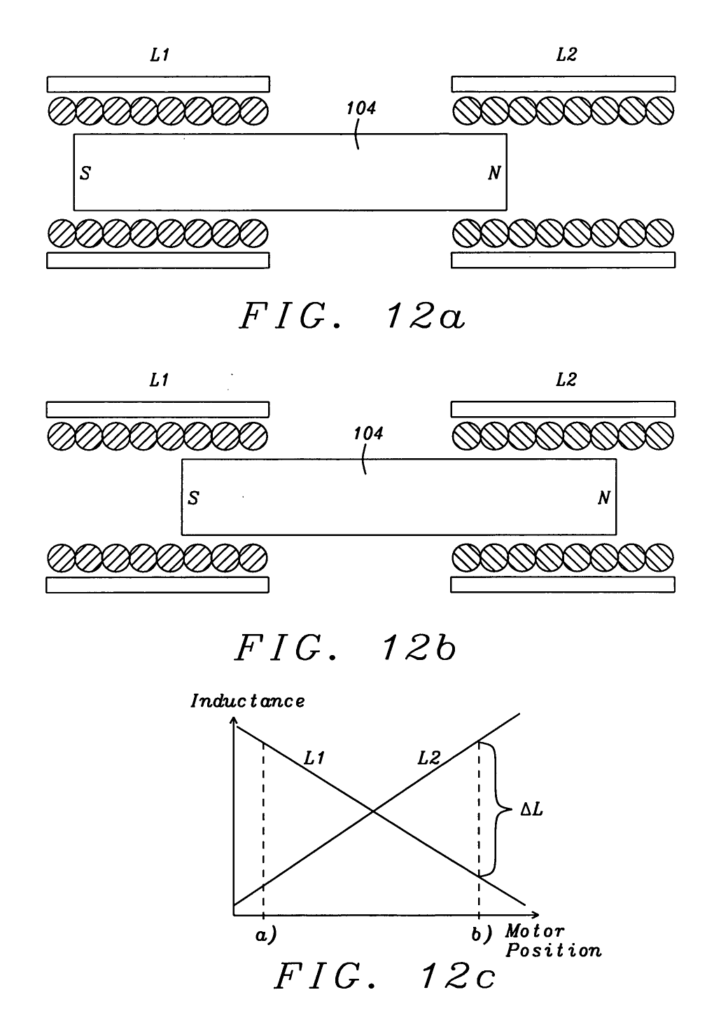

FIG. 10a shows the function principles of a first embodiment of a power transmission used with the present invention. It shows two coils A and B wrapped around a fixed iron 100. Two permanent magnets 102 are deployed building each a magnetic field towards the coils/iron combination. The directions of currents through the coils A and B are indicated by either dots or crosses generating a magnetic field either upwards to the permanent magnet or downward to a coil dependent upon the direction of the currents. FIG. 10 b shows that the movable optical element, indicated by numeral 101, moves to the left direction, depending upon the direction of currents through the coils. FIG. 10 c shows that the movable optical element 101 moves to the right side. The permanent magnets 102 can be directly fastened on the optical element or on a carrier, which is fixedly connected to the movable optical element.

FIG. 10d shows the function principles of a second embodiment of a power transmission used with the present invention. A permanent magnet 104 is moving between two coils A and B. FIG. 10e shows that the permanent magnet 104 moves to the left side dependent upon the direction of currents through both coils A and B. FIG. 10f shows that the permanent magnet 104 moves to the right side dependent upon the direction of currents through both coils A and B. The permanent magnet 104 is fixedly connected to an optical element, thus moving the optical element into a position desired.

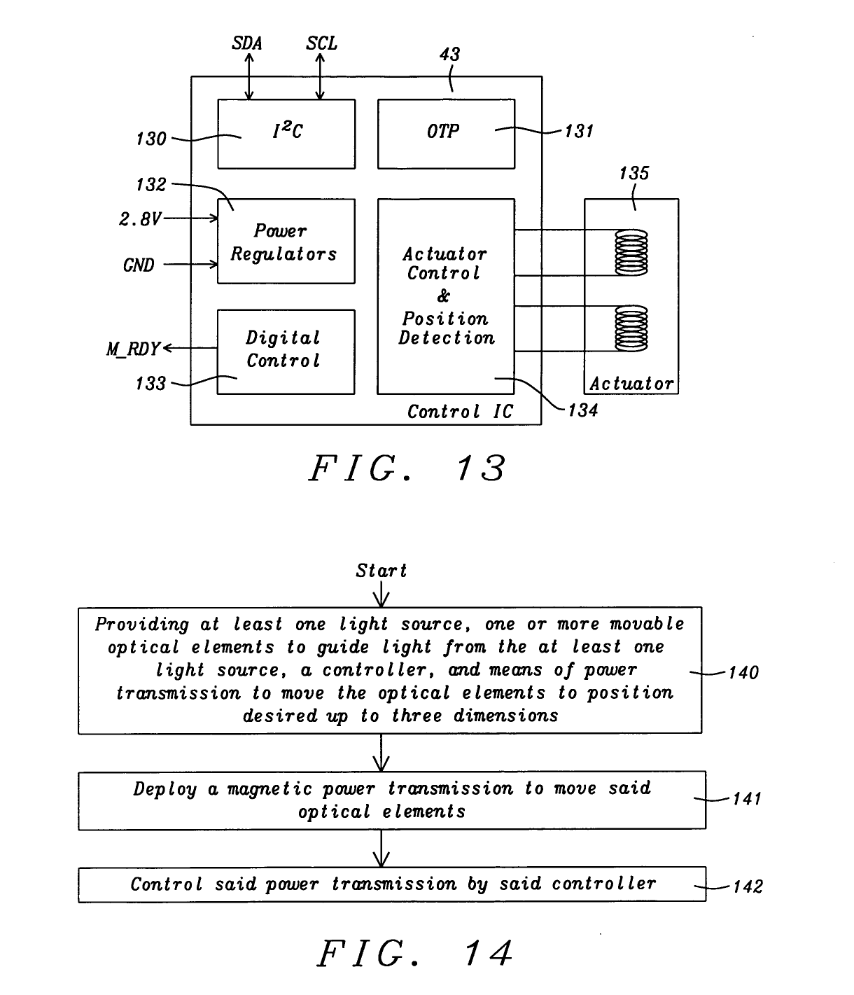

FIG. 11a+b illustrate how the inductances L1 and L2, i.e. of coils A and B in FIGS. 10a-c, vary dependent on the positions of the moving part of the motor, i.e. the positions of the permanent magnet 102. In FIG. 11a the permanent magnets inclusive the optical element 101 was moved the right, while in FIG. 11b the permanent magnets inclusive the optical element 101 was moved the left. The diagram of FIG. 11c illustrates the dependency of the inductances of L1 and L2 and how thus the difference Δ L of inductances of both coils L1 and L2 can be used to determine the exact position of the motor.

FIGS. 12a-c illustrate, according of the embodiment of the linear motor shown in FIGS. 10d-f how the inductance of coils L1 and L2 vary dependent on the positions of the moving part of the motor, i.e. in this case the positions of the permanent magnet 104 moving inside of the coils L1 and L2. In FIG. 12a the permanent magnet 104 was moved the left, while in FIG. 12b the permanent magnet 104 was moved the right. The diagram of FIG. 12c illustrates the dependency of the inductances of L1 and L2 and how thus the difference Δ L of inductances of both coils L1 and L2 can be used to determine the exact position of the motor.

It should be noted that alternatively to the position sensing integrated in the linear actuator described above, the position of optical elements could be determined by capacitive sensors or by Hall sensors. Only one coil can be deployed alternatively to generate the power transmission to the movable parts.

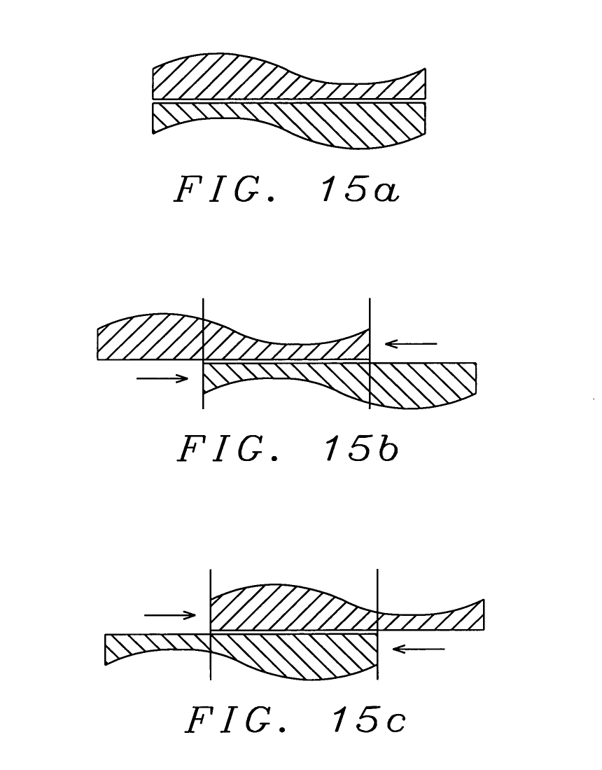

FIG. 13 depicts a block diagram of the basic functions of a control module or control processor 43 for the lighting system invented. Any suitable type of control processor could be used to control the light system invented. In a preferred embodiment of the invention all functions are integrated in an integrated circuit (IC). The control module comprises for a serial bus 130 an inter-Integrated circuit (I²C) bus to a control bus (SDA and SCL), a one-time programmable memory (OTP) 131, power regulators 132, a digital control module 133 and a actuator control/position control module 134, which is connected to two coils 135 of a power transmission, i.e. linear motor, to move the optical elements of the lighting system invented. A single coil could be used for the power transmission as well. The position detection feature senses a difference of inductance between both coils and determines an actual position of the optical elements based on the difference of inductance.

It should be noted that one control IC could control multiple actuators. In a preferred embodiment of the present invention a control IC does control all actuators used as well as one or more LEDs, wherein other light sources are applicable as well.

Another advantage of the present invention on hand is that the positions are variable and can be progressively taken and appointed. Therefore using a linear motor with integrated position sensing can be used advantageously. Known systems with, for example, stepper motors, can only take a position “step by step”. This effect works at a disadvantage to visual systems because light distribution needs the most continuous procedure and positioning of the, for example, optical elements, possible. Otherwise the lighting changes would be erratic and/or the optical elements wouldn't be able to be used completely in their resolution.

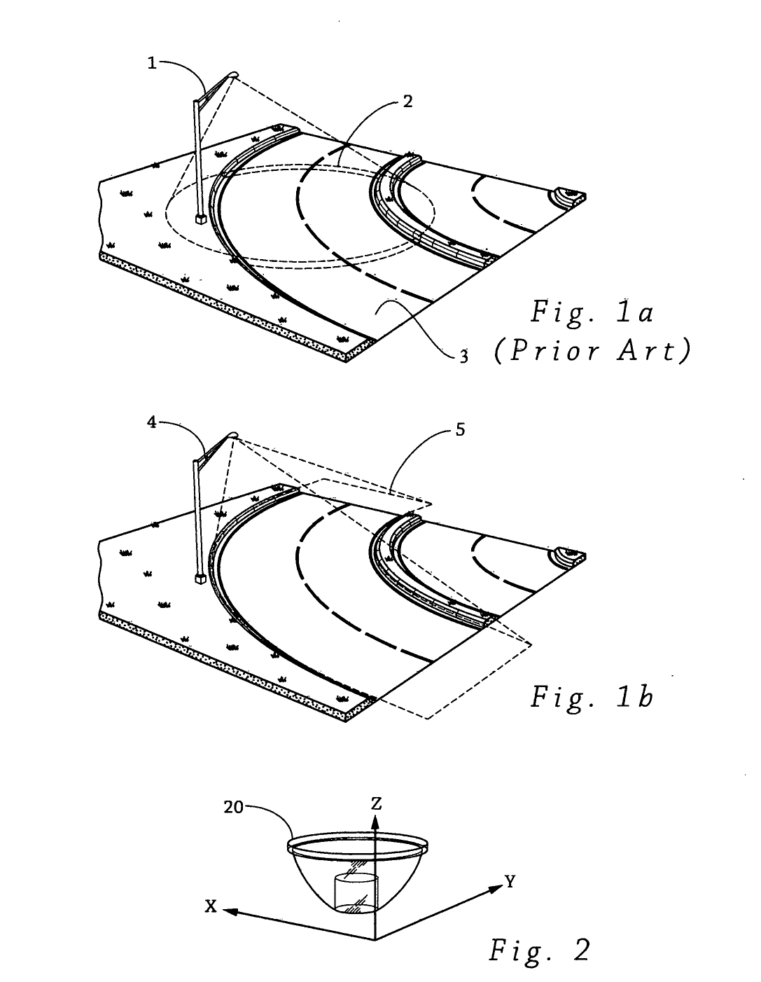

The moving parts can be positioned linearly, two dimensionally in an x, y direction, or three dimensionally (x, y, z). Through the various positions of the optical element in relation to the light source, a number of different light distributions or illuminations on illuminated objects can be produced. FIG. 2 shows axial definitions for a light deflector 20 with three dimensionally deflection directions x, y, z. It should be noted that the optical elements could be tilted as a part of the possible movements.

It should be noted that for each direction, e.g. three directions, a linear motor could be deployed to modify light distribution. Alternatively along the optical axis, light distribution can be modified by one or more variable lenses. Such a lens can be made of a transparent, flexible plastic container filled with water or another fluid. Another benefit is that the water itself can be used for cooling.

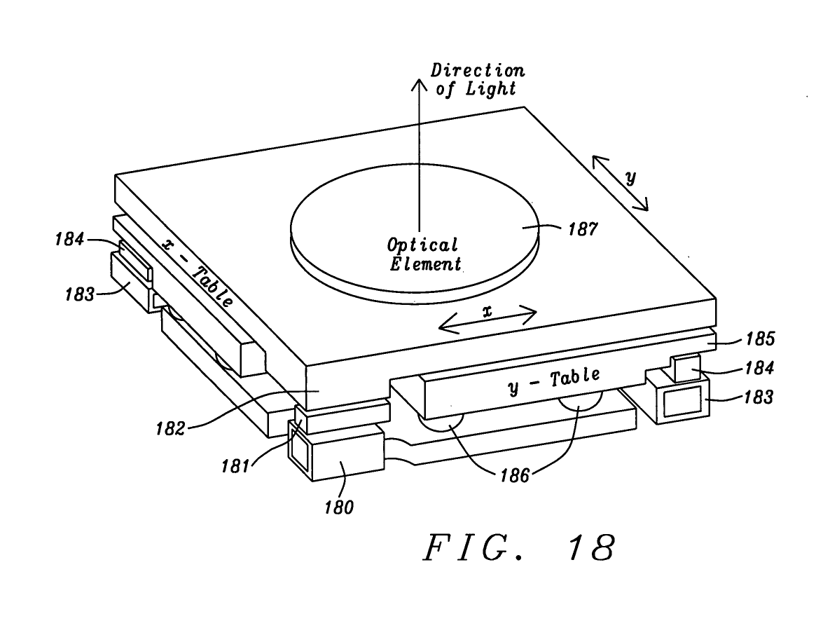

FIGS. 17 a-c show how the optical properties of a fluid-filled lens can be changed by changing the amount of fluid of the lens. The amount of fluid can be modified by a pump and the pumped fluid changes the shape of the lens and hence the light distribution. FIG. 17a shows such a variable lens comprising a lens mounting, a flexible plastic membrane and a transparent fluid membrane. FIG. 17b illustrates such a lens having the fluid partly pumped out, hence having the properties of a concave lens. FIG. 17c illustrates such a lens having additional fluid pumped in, hence having the properties of a convex lens. The pump can be activated by the movements of the dynamic lighting system invented.

Alvarez and Lohmann lenses are variable focus optical devices based on lateral shifts of two lenses with cubic-type surfaces. These kinds of lenses can be used to modify light distribution.

FIGS. 15 a-c illustrate Alvarez lens technology comprising two optical elements (lenses) that can be used to generate different light distributions. The movement of one or more optical elements with different shapes changes the light distribution. The shapes could form a complete optical element or be based on micro-structures in which multiple micro Alvarez lenses are integrated on optical elements.

FIGS. 15 a-c show how a Alvarez lens changes its focus by laterally moving either the upper or lower lens component or both lens components.

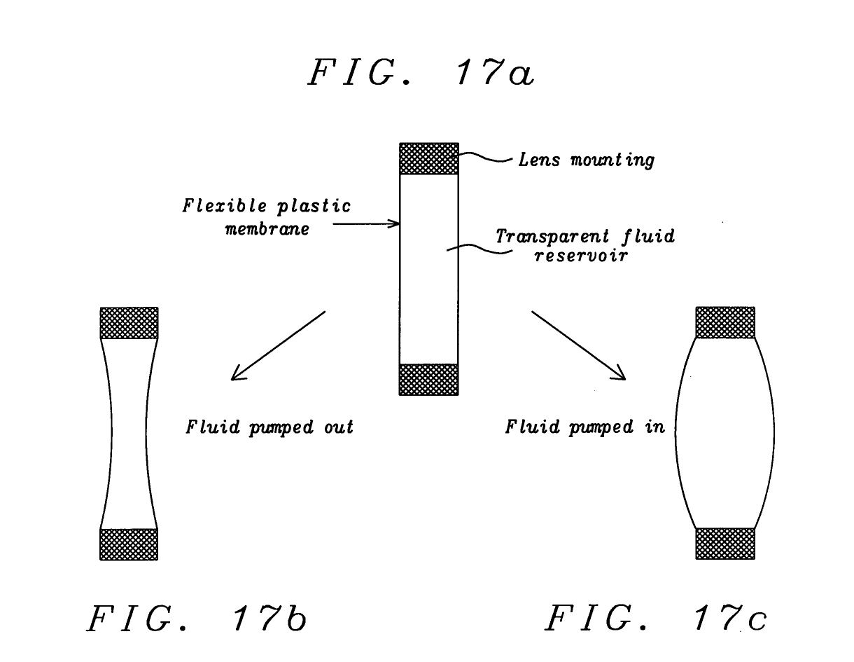

FIGS. 16 a-f show schematic functions of Alvarez- or Lohmann (alternative solution to the Alvarez lens) lens systems. A light source 160 generates a light beam 161 through the variable lens comprising a first 162 and a second part 163, wherein the relative positions of both parts can be changed by moving either one or two parts of the lens. Outer cubic surfaces configuration at: (a) neutral position, (b) negative power addition, and (c) positive power addition. Inner cubic surfaces configuration at: (d) neutral position, (e) negative power addition, and (f) positive power addition. For the outer cubic surfaces configuration there must be a space between both lenses to avoid collision when the shift is done to achieve positive power addition (f).

The present invention can also provide that, dependent upon the position, the brightness of the spot light source (ideally one or more LEDs) can be changed. At the same time flexible light intensity depending on the angle can be achieved. Another embodiment of the invention steers various LEDs (e.g. in different colours) dependent upon the angle position.

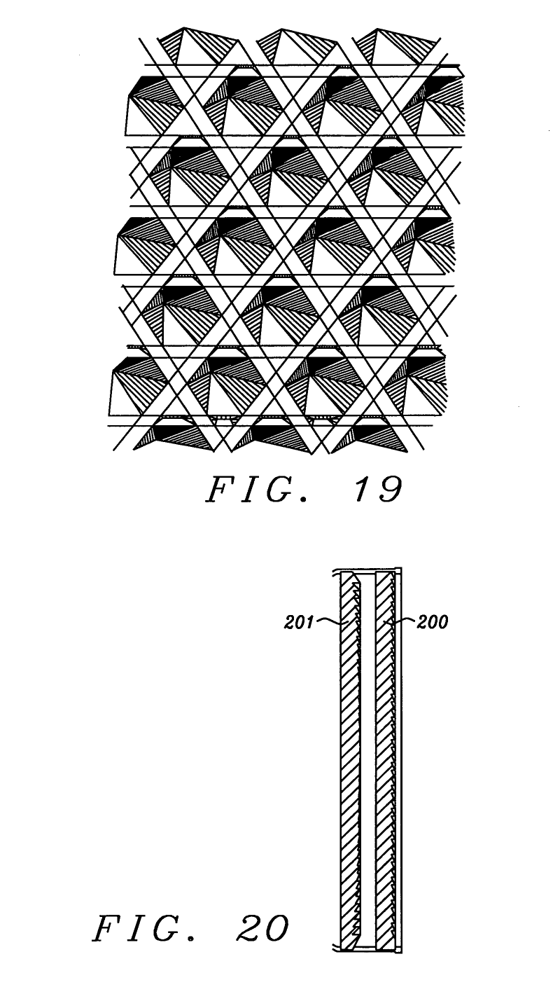

FIGS. 19-20 show another embodiment of the present invention, namely a lighting system using micro-structured optics. This micro-structured optics are an implementation of Alvarez-lenses comprising instead of one or two lenses a multitude of lenses, such as a Fresnel-lens on the surface of the lighting system. The Fresnel lens reduces the amount of material required compared to a conventional spherical lens by breaking the lens into a set of concentric annular sections known as “Fresnel-zones”, which are theoretically limitless. In a preferred embodiment these Fresnel lenses are deployed in two layers that can be moved, similarly to Alvarez-lenses, in relation to each other by a magnetic field. The advantage of this embodiment is that movements are minimized to achieve an optical effect and the mass of optical parts can be significantly reduced.

FIG. 19 shows a top view of an enlarged clipping of the surface of an optical element of the lighting system invented in which micro-structured optics are integrated.

FIG. 20 illustrates a side view of two optical elements (plates) 200 and 201 with micro-structured surfaces. One or both optical elements 200 and 201 can be moved vertically in order to change the optical behavior. It is also possible that more than two layers are used wherein one or more layers could be moved.

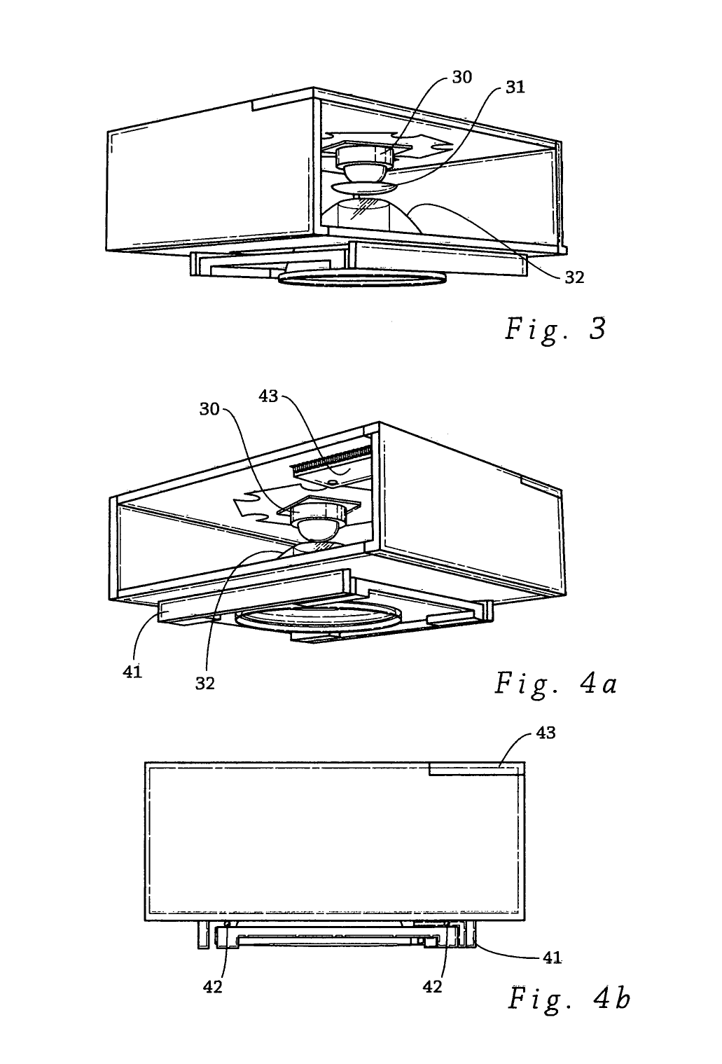

FIG. 3 illustrates an embodiment of the dynamic lighting system with position steered optics using an intermediate optical element 31. Furthermore FIG. 3 shows a light source 30 and a movable optical element (deflector) 32.

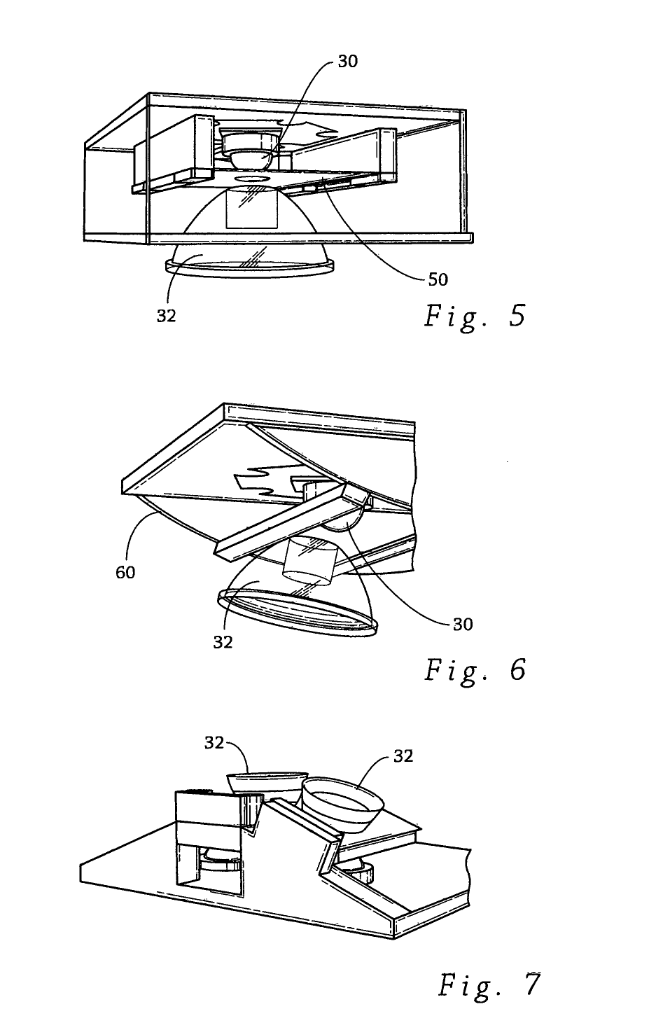

FIG. 4a illustrates a basic idea of the present invention. It shows an oblique view of the lighting system invented. A movable primary optical element (deflector) 32 is moved across a light source 30. A movable x-y table 41 carries the movable optical element 32. The x-y table 41 is moved by power transmission (not shown) to a position desired as described above and is guided by a bearing, which can be e.g. a plain bearing or a ball bearings. A control module 43 controls the power transmission to move the movable optical elements and the light source 30, e.g. a LED. In some embodiments of the present invention the control module 43 controls more than one light source.

FIG. 4b shows a side view of the lighting system of the present invention, wherein the x-y table 41 is guided by balls 42 of ball bearings. FIG. 4b illustrates how the movable optical element is linked to the static elements of the lighting system invented.

FIG. 5 shows another embodiment of the lighting system invented using a secondary steered movable intermediate optical element 50 as well as a primary steered optical element 32 to control the flux of light. It would be also possible to deploy more than two steered optical elements. Preferably the intermediate optical element is moved because it has a reduced mass but of course it's possible to build the optical system having more than one movable optical element.

FIG. 6 shows another embodiment of the lighting system invented with position dependent optics moving not only linearly but also on spherical tracks 60.

It is also possible to revolve optical elements around their own axis in a wobbling motion. In this case in a preferred embodiment the optical element is hung with springs. Furthermore it should be noted that any kind of movement, including tilting, of one or more optical elements could be realized with the present invention and changing of positions of one or more optical elements includes tilting.

FIG. 7 shows a luminary according the present invention, comprising multiple light sources combined in a complete lighting system with a number of optical elements and numerous magnetic transmission stretches. By an overall control of the multiple light sources different variable light distributions can be realized. The multiple light sources can be controlled in parallel or be controlled individually. Each light source and each optical element can be controlled independently.

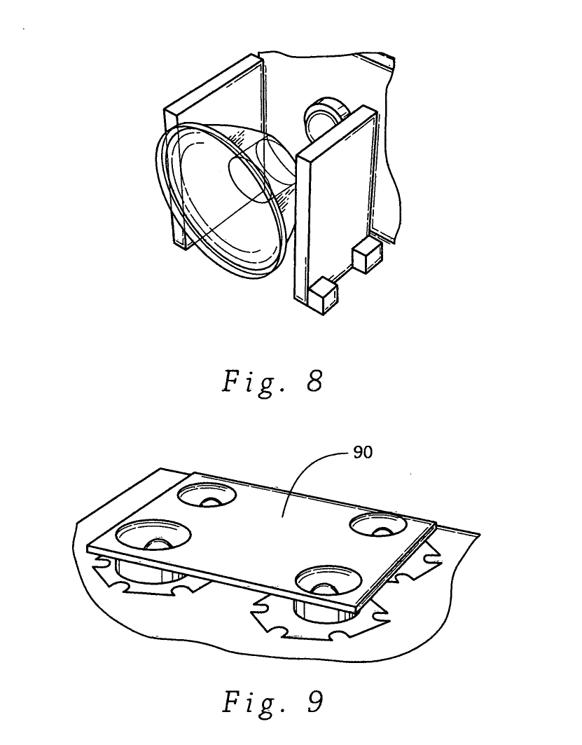

FIG. 8 depicts a lighting system invented having horizontal deflection. Key of the system of FIG. 8 is the movement in the direction of the optical axis.

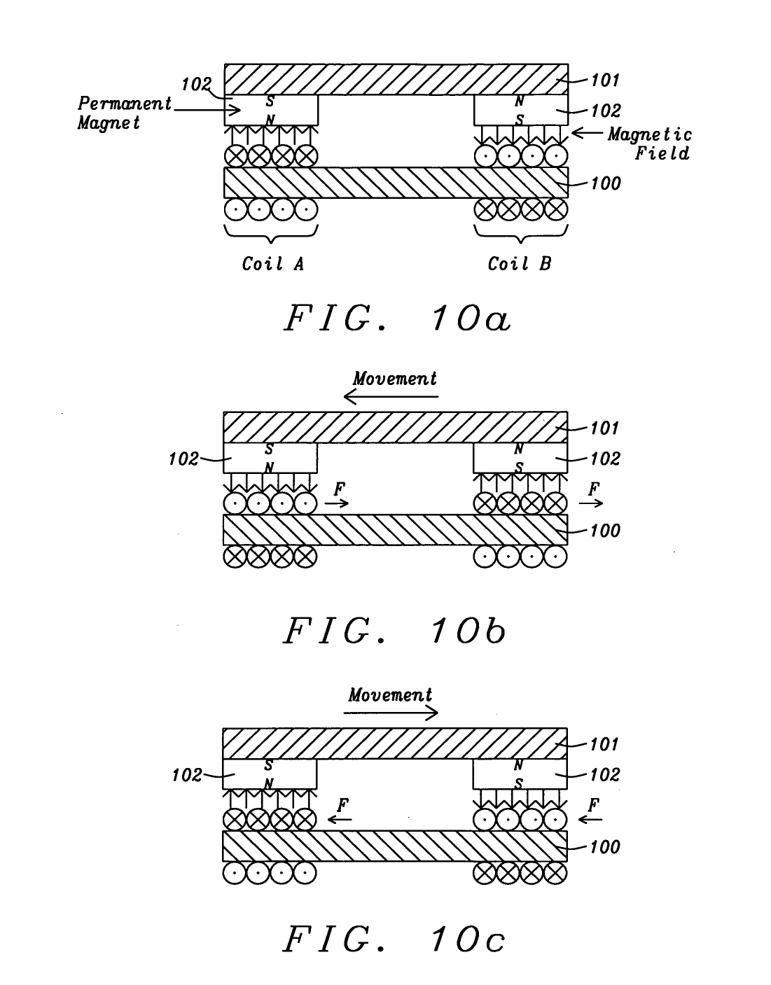

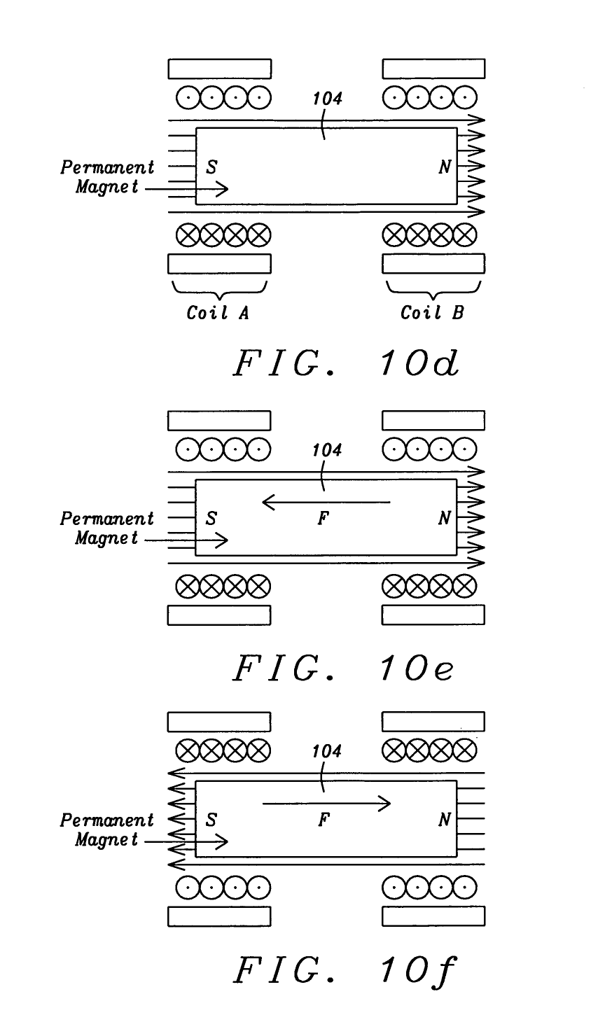

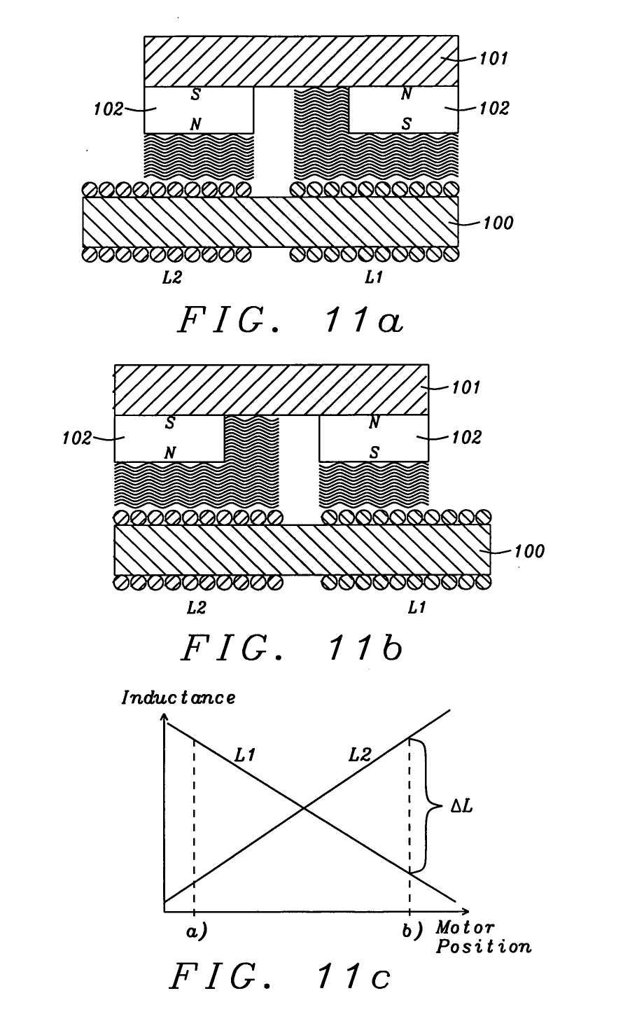

FIG. 9 depicts another multiple lighting system according to the present invention. An array of LED light sources is controlled by a common optical element 90. It should be noted that various types of LEDs can be used with the present invention, e.g.: single LED die, multiple LED dies (connected in series or in parallel or combinations), white or colored LEDs or LED die(s), blue LED as a primary emitter and a remote phosphor conversion. The conversion could be done at the optical elements.

Other types of light sources could be used as well.

FIGS. 4-9 illustrate clearly that multiple variations of the lighting system invented are possible and it should be understood that combinations of the lighting system illustrated are obviously possible. Furthermore it should be noted that the lighting system invented could be encapsulated as a unit.

Another embodiment of the invention is characterized by a link of the position with external control signals. The steering information can be taken from various sources depending on the application such as:

#Manual control element for adjusting the position
# Motion detector
# Vibration sensors and tilt sensors
# Curve pathways of moved objects
# Brightness sensors
# Heat sensors (Infrared)
# Software programmes (processes, timing)
# Mobile devices (Cell phones, PDA's)
# Solar devices including the positions of the sun

It should be understood that the signals above are non-limiting examples. Other signals are possible as well with the present invention.

The results of the example of the signals shown above are the following adjustable parameters of the light delivered:

# Light cone (small beam width, large beam width)
# Light direction (angles of the optical axis)
# Light distribution (shape, symmetric, asymmetric)
# Intensity distribution and color distribution

Other lighting effects can be achieved as well. The steering of the light sources, e.g. of LED, OLED, etc., in dependence upon the positions of the movable optical elements is variable. It can be modified any time or synchronized and variously colored light sources can be accessed upon the positions of the optical elements.

The light guidance occurs through shifting the relative position between the light-giving source and one or more optical elements. In the course of this the movement can be either straight (x, y, or z) or it can be conducted onto a spherical course. The effect of the light guidance can be increased by using one or more light sources having narrow light distribution (e.g. 10°) or a collimator so that the primary emission is closely focussed on the delivering light source or light collimating (collimated light is light whose rays are nearly parallel) is carried out. A special embodiment pertains to the use of light mixing optics that collimate at the same time and the light is ultimately diverted over an animated visual effect.

Because the present invention doesn't require a solid mechanical, linked system between the rigid and the moving parts, an exact mechanical positioning of the moving parts is not used purely through the setting adjustments. The invention provides for determining the position over the same magnetic pathway that is used for power transmission in that a test current is laid on the magnet coil and the induction potential is measured as disclosed e.g. in the patent application DI08-004, titled “Camera Shutter”, Ser. No. 12/658,508, filing date Feb. 5, 2010, and in the patent application DI09-007, titled “Twin-actuator configuration for a camera module”, Ser. No. ______, filing date ______.

Thus it is possible to determine the exact position of the moved part or parts. Beside the static adjustment of a particular position and the subsequent particular light guidance, the invention also provides for the moved parts to be moved dynamically at a certain frequency. Depending on the size and mass of the part that is to be moved, it can take place either directly or indirectly; for example over a smaller inter-optic with less mass. Through the movement of the optics with higher frequencies (over 100 Hz) effects can be achieved as e.g. adjustments to light distribution curves and optical diffusers with high efficiency.

Light systems based on LED technology still have a lot of problems when it comes to high temperature development. The high delivery power on the LED chip causes a power loss that has to be discharged thermically over the LED system in order not to exceed the temperature limits of the LEDs. The present invention opens the possibility of combining the dynamic behaviour of the optics with the cooling of the LEDs. Through the cyclic process, airflows can be created in connection with the mechanical housing that can be used to cool the LEDs and the LED system. If a specific visual effect position is static, the optics can be made to vibrate through small displacements that create airflow and in consequence, cool the LED system. It is also possible to shift the optic elements around a fixed working point and get the vibrations.

The present invention also takes into account that OLED foils change their shape and position. The power transmission affects the OLED foils and deforms them by, for example pushing them together. In this way, new light distribution characteristics are created. The basis technology stays the same as for the LED application.

Furthermore it should be noted that a mechanical brake or lock could be applied to the moving parts when their movements are switched off. Moreover a home position can be defined for the moving parts whereto they return if the lighting system is switched off.

Furthermore a calibrating routine can be activated when the lighting system is switched on in order to determine the exact positions of the one or more movable parts. The impact points of the power transmission are thus navigated and the related data is evaluated electronically.

It should be understood that different types of light sources could also be used with the present invention. In preferred embodiments of the present invention LED or optionally OLEDS have been deployed. Alternatively all light sources that deliver a point light could be used as well as e.g. miniaturized discharge lamps.

In the following sections are some non-limiting examples of applications of the present invention described:

### # General Lighting

In this area of application a change of the light according to the situation is desired. For example in the case of a “task light” it may be required that the entire table area be illuminated, whereby in the case of a reading task, the light should be focussed mainly on the reading area. Steering the light for both lighting tasks could be done by keeping the light intensity at one level—like the surface of the table—at a constant. In this way the smaller light cones save energy because the electric output is reduced.

### # Lamps (Light Bulbs)

Incandescent light bulbs are banned legally in many countries. Alternative lamps are needed for the market. Lamps based on LEDs are a preferred option and multiple products are available. Light Bulbs based on this invention will have the opportunity to change the light direction, shape of light distribution. Different operation mode may be changed by a switch integrated in the bulb or by pressing the mains switch multiple times or by wireless/remote commands (e.g. IR) or by a phase cutting dimmer.

### # Street and Pathway Lighting (Also Escape Routes)

With pathway lighting there is the requirement that not only the pathway itself has a specific minimum light intensity but also that a maximum ratio of minimal to maximum light intensity must not be exceeded. Both of these requirements can be adapted with the present invention. Because the light intensity can be changed dependent upon the angle of illumination, the light distribution curve can be adjusted to the desired shape and intensity distribution. In this way, for example, curves can be illuminated correctly and the distance from lamp to lamp can be increased by a homogeneous light, which in turn reduces the investment costs of the lighting system.

Homogeneousness is also required with emergency lighting equipment on escape routes. Classic lighting systems have less light intensity at the edge of the illumination light cone than in the centre of the lamps. This present invention can greatly improve the homogeneousness through dynamic control of the lighting dependent upon the illumination angle. The energization of the light sources is increased at the edges of the radiated lighting and with that the illumination is increased.

### # Car Headlights

Bending light is a well-known application of flexibly steered light. The present invention makes it possible to carry out fast changes in light control. With this, it is possible to compensate for the automobile's vibrations and to stabilize the light when the vehicle is moving. Tilt information makes it possible to adapt the horizontal illumination angle so that glare effects from oncoming vehicles is avoided. The car headlights of the present invention can also be curve lights, i.e. a curve light angle is determined by the car's speed and steering angle, which can be analyzed by sensors.

### # Stage and Theatre Lighting

The task in this application is, for example, to track a person e.g. on the stage around with the light. Using position detection, the light can track a moving object automatically. Manual steering is known and this can also be covered by the present invention. The advantage here is a quick response time.

### #Accent Lighting

The technology presented here makes new applications in the area of accent lighting possible. Especially the fact that in dependence upon the optical deflection, various light intensities and colours can be steered which allows for the depiction of, for example, a rainbow colour effect on walls with one single lighting system.

### # Beamer

Another kinds of applications for the described technology are beamer applications whereby a miniaturized application of the present invention is assumed. Through joint circuiting of a number of systems that are based on the invention, light overlays can be achieved in an array that creates a colour blend on a depictive surface. By using various colors, color pictures can be projected on surfaces.

It should be noted that the control of the moving optical elements ensures that the illumination of moved objects is stabilized, whereby tilt or vibration information is fed for the compensation of the moved object. This stabilization could be applied for e.g. track lights on boats, searchlights, car lights, etc.

FIG. 18 shows an oblique view of main components of a preferred embodiment of the present invention. A first coil 180 wrapped around an iron generates a magnetic field moving a permanent magnet 181 in x-direction, wherein the magnet 181 is firmly connected to an x-table 182. Another coil (not visible), deployed diagonally to the first coil 180, generates also a magnetic field moving a related permanent magnet in x-direction. The x-table 182 is guided by balls (not visible) of a ball bearing moving in x-direction.

A second pair of coils 183 each wrapped around an iron generates a magnetic field moving each a permanent magnet 184 in y-direction, wherein the magnet 184 is firmly connected to a y-table 185. The y-table 185 is guided by balls of a ball bearing moving in y-direction.

The optical axis, i.e. the direction of light, of the lighting system shown in FIG. 18 is perpendicular to the x- and y-direction. An optical element 187 is deployed on top of the x-table and can be moved accordingly.

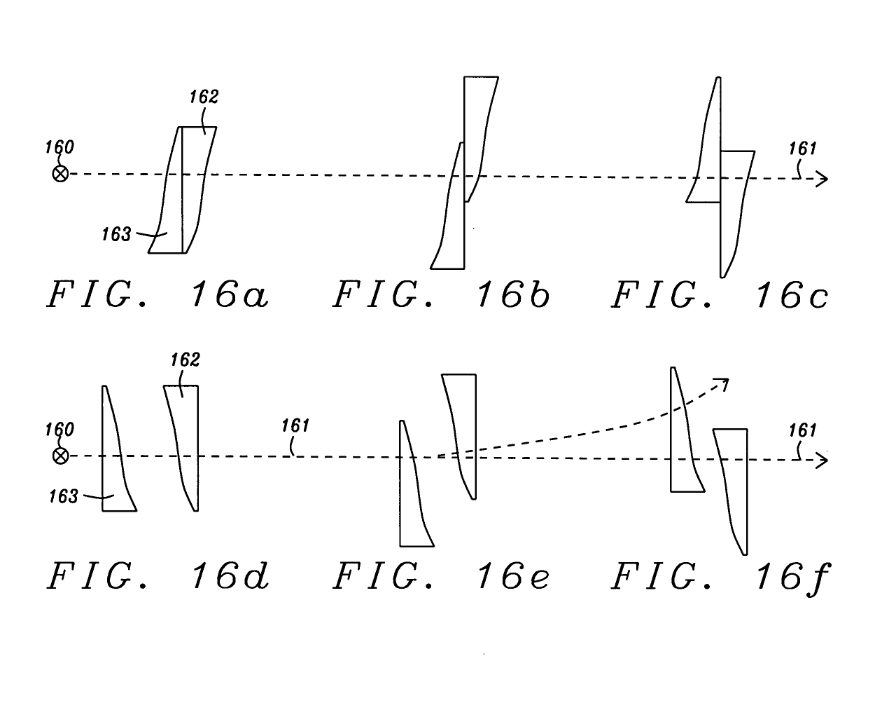

FIG. 14 illustrates a flowchart for a method for dynamic lighting systems, avoiding mechanical tension, enabled having utmost flexible positioning. Step 130 describes the provision of at least one light source, one or more movable optical elements to guide light from the at least one light source, a control module, and means of power transmission to move the optical elements to position desired up to three dimensions. The next step 131 teaches deploying a magnetic power transmission to move said optical elements, followed by the last step 132 describing controlling said power transmission by said control module 43. Optionally the actual positions of the one or more movable optical elements are sensed and fed to the control module in a control loop.

While the invention has been particularly shown and described with reference to the preferred embodiments thereof, it will be understood by those skilled in the art that various changes in form and details may be made without departing from the spirit and scope of the invention.

What is claimed is:

1. A dynamic lighting system comprising the following steps:
at least one light source;
at least one movable optical element guiding light from said at least one light source;
a power transmission changing a position of said at least one movable optical element by a magnetic field; and
means of bearing being connected to a static element of the lighting system guiding said at least one movable optical element.

2. The system of claim 1 wherein said light source is at least one LED.

3. The system of claim 2 wherein applicable types of LEDs include single LED die, multiple LED dice, which may be connected in series or in parallel or combinations, white or colored LEDs or LED dice, and blue LED as a primary emitter and a remote phosphor conversion, wherein the phosphor conversion can be performed at the at least one optical elements.

4. The system of claim 1 wherein said light source is an OLED.

5. The system of claim 1 wherein different types of light sources are used.

6. The system of claim 1 wherein tilt information comprises values of pitch and yaw deviations.

7. The system of claim 1 wherein at least one optical element can be positioned in x-direction, wherein the power transmission takes place using at least one moving part over a controlled magnetic field.

8. The system of claim 1 wherein more than one optical element can be positioned each in different directions.

9. The system of claim 1 wherein said least one optical element can be positioned in x-, -y and -z direction.

10. The system of claim 1 wherein said least one optical element can be positioned by tilting.

11. The system of claim 1 wherein said at least one movable optical element is moved on spherical tracks.

12. The system of claim 1 wherein said at least one movable optical element is revolved around its own axis.

13. The system of claim 12 wherein said at least one optical element is hung with springs.

14. The system of claim 1 wherein actual positions of said one or more optical elements are measured by measuring differences of inductance of coils used to generate said controlled magnetic field and wherein the results of this position measurement is used to control movements of the optical elements.

15. The system of claim 1 wherein actual positions of said one or more optical elements are measured by using capacitive sensors and wherein the results of this position measurement is used to control movements of the optical elements.

16. The system of claim 1 wherein actual positions of said one or more optical elements are measured by using Hall sensors and wherein the results of this position measurement is used to control movements of the optical elements.

17. The system of claim 1 wherein various positions of the at least one optical element produces various light illumination angles.

18. The system of claim 1 wherein various positions of the at least one optical element produces light distribution curves.

19. The system of claim 1 wherein movements of the at least one optical element is used for the production of an airflow wherein the optic elements are vibrated.

20. The system of claim 1 wherein the at least one optical element is shifted around a fixed working point and gets vibrated.

21. The system of claim 1 wherein the at least one optical element is moved with a defined frequency.

22. The system of claim 19 wherein said frequency is above visual perception

23. The system of claim 1 wherein the at least one optical element is moved dependent upon external control signals.

24. The system of claim 1 wherein the steering of the light sources in dependence upon positions of the at least one optical element is variable.

25. The system of claim 1 wherein the steering of the light sources in dependence upon positions of an entirety of the optical elements is variable.

26. The system of claim 1 wherein variously colored light sources are accessed upon the positions of the optical elements.

27. The system of claim 1 wherein the steering of the light sources in dependence upon positions of the optical elements is synchronized.

28. The system of claim 1 wherein there is a mechanical lock applied for the at least one optical element if the movements are switched off.

29. The system of claim 1 wherein a calibration routine is activated when the system is switched on in order to determine the exact position of the at least one optical element.

30. The system of claim 27 wherein the impact points of said power transmission are navigated by said calibration routine and the data is evaluated electronically.

31. The system of claim 1 wherein a shape of an OLED foil is changed by the power transmission.

32. The system of claim 1 wherein the controlled magnetic field is generated by at least one coil.

33. The system of claim 1 wherein at least one permanent magnet is deployed on the side of the movable optical elements.

34. The system of claim 1 wherein said one or more optical elements are guided by one or more ball bearings.

35. The system of claim 34 wherein balls of said ball bearings are conducting electrical currents.

36. The system of claim 1 wherein said one or more optical elements are guided by one or more plain bearings.

37. The system of claim 1 wherein the system is encapsulated as a unit.

38. The system of claim 1 wherein a predefined light control is performed.

39. The system of claim 1 wherein in dependence upon an optic deflection energization of light sources in order to obtain a constant light intensity on an illuminated surface.

40. The system of claim 1 wherein said power transfer is performed by a controlled magnetic field.

41. The system of claim 1 wherein the lighting system comprises a control module.

42. The system of claim 41 wherein the control module is integrated in an integrated circuit.

43. The system of claim 41 wherein the control module comprises a serial bus to a control bus, a one-time programmable memory, power regulators, a digital control module, and an actuator control module.

44. The system of claim 41 wherein said control module comprises a position control module to control the position of the at least one actuator.

45. The system of claim 41 wherein said control module controls said at least one light source and the positions of all said optical elements.

46. The system of claim 41 wherein said control module controls each of the light sources individually.

47. The system of claim 1 wherein said at least one movable optical element comprises an optical lens.

48. The system of claim 47 wherein said optical lens is a variable lens.

49. The system of claim 48 wherein said variable lens is an Alvarez lens.

50. The system of claim 48 wherein said variable lens is a Lohmann lens.

51. The system of claim 48 wherein said variable lens comprises a transparent, flexible container filled with fluid.

52. The system of claim 51 wherein said container is filled with water.

53. The system of claim 51 wherein the amount of fluid in the container can be modified by a pump.

54. The system of claim 51 wherein the pump can be activated by movements of the dynamic lighting system invented.

55. The system of claim 1 wherein said at least one movable optical element comprises a lens micro-structure.

56. The system of claim 55 wherein each of two layers of an optical element have micro-structured surfaces wherein one or both layers can be moved in relation to each other in order to generate optical effects.

57. The system of claim 55 wherein each of more than two layers have micro-structured surfaces wherein one or more layers can be moved in relation to each other in order to generate optical effects.

58. The system of claim 1 wherein all optical elements are moved to a home position when the lighting system is switched off.

59. A method for dynamic lighting systems avoiding mechanical tension enabled having utmost flexible positioning, comprising the following steps:
(1) providing at least one light source, one or more movable optical elements to guide light from the at least one light source, a control module, and means of power transmission to move the optical elements to position desired up to three dimensions;
(2) deploying a magnetic power transmission to move said optical elements; and
(3) controlling said power transmission by said control module.

60. The method of claim 59 wherein said at least one light source are any types of LEDs.

61. The method of claim 59 wherein said at least one light source are OLEDs.

62. The method of claim 59 wherein said magnetic power transmission comprises at least one coil wrapped around magnetic material and at least one permanent magnet fixedly connected to a movable optical element.

63. The method of claim 62 wherein the at least one optical element is moved with a defined frequency.

64. The method of claim 63 wherein said frequency is above visual perception.

65. The method of claim 59 wherein the method is applied for stage lighting wherein using position detection the light of the light source can follow a moving object automatically.

66. The method of claim 59 wherein the method is applied for general lighting being enabled to change the light as required by lighting tasks.

67. The method of claim 59 wherein the method is applied for street and pathway lighting being enabled to change the light intensity dependent upon an angle of illumination.

68. The method of claim 59 wherein the method is applied for car headlights being enabled to carry out fast changes of light control in order to compensate for vibrations and adapting horizontal illumination angles to avoid glare effects dependent upon an angle of illumination.

69. The method of claim 68 wherein said car headlights are enabled to be used as curve lights.

70. The method of claim 59 wherein the method is applied for light bulbs of lamps, wherein the light bulbs of the present invention can change light direction and a shape of light distribution activated by switching means.

71. The method of claim 70 wherein said switching means is a switch integrated in the bulb.

72. The method of claim 70 wherein said switching means is a main switch which can be pressed multiple times and different operation modes depend on a number of times the main switch is pressed.

73. The method of claim 70 wherein said switching means are wireless commands.

74. The method of claim 70 wherein said switching means is a phase cutting dimmer.

75. The method of claim 59 wherein actual positions of the one or more movable optical elements are sensed and fed to the control module in a control loop.
